(19) United States
(12) Patent Application Publication
(10) Pub. No.: US 2011/0005280 A1
(43) Pub. Date: Jan. 13, 2011

(54) ARTICLE FOR LOCKING AN ACCESSORY TO A PHYSICAL STRUCTURE USING A SEPARATE LOCKING DEVICE AND THE COMBINATION THEREOF

(76) Inventor: Blake D. MILLS, IV, San Francisco, CA (US)

Correspondence Address: CHARTER IP, LLC, P.O. BOX 64, The Plains, VA, 20198, US

(21) Appl. No.: 12/831,021

(22) Filed: Jul. 6, 2010

Related U.S. Application Data
(60) Provisional application No. 61/270,433, filed on Jul. 8, 2009.

(51) Int. Cl. E05B 67/38; F16G 11/00

(52) U.S. Cl. 70/51; 24/713

(57) ABSTRACT

In an article for locking an accessory to a physical structure using a separate locking device, and a combination thereof, the article includes an elongate flexible rope having its ends secured, in which the rope has a twist so as to form two separate loop openings. A stop is provided at the location of the twist; the stop having a central opening enclosing the twist. One of the first and second loop openings is configured to be drawn up through an opening of the accessory until the stop abuts an interior surface within the accessory. The drawn up one of the first and second loop openings extends outside the accessory for receiving the separate locking device there through to lock the accessory via said one of the first and second loop openings and locking device to the physical structure.

### PRIORITY STATEMENT

The present application claims the benefit under 35 U.S.C. §119(e) of U.S. provisional patent application Ser. No. 61/270,433 to the inventor, filed Jul. 8, 2009, the entire contents of which is hereby incorporated by reference herein.

### BACKGROUND

1. Field

Example embodiments of the present invention in general relate to an article for locking an accessory to a physical structure using a separate locking device, and the combination thereof.

2. Related Art

There are known mechanisms or articles that hold an accessory to a fixed external structure via a separate locking device. In a conventional example, in the purview of a lock for a bicycle for example, where a conventional U-lock or other padlock device is typically employed, an article for securing an accessory (such as a helmet) to a separate locking device (such as a U-lock) includes a flexible cable loop with a permanent stop fixed at one end thereof. The loop is passed through an opening in the helmet, but the stop at the other end will not pass through the opening without permanently damaging either the stop or the helmet.

The bicycle lock is then passed through the article's loop after it's passed through the aperture in the helmet while locking the bicycle to some fixed structure; then the lock is locked. The stop on the article secures the helmet/accessory against theft.

This conventional article for securing accessories such as bike helmets to separate locks is deficient in that there is no reasonable carry of stow position for the article when not in use. If stowed on the bike frame or bike lock itself, the article will free swing around the axis of the loop end, as the center of gravity or weight is at the permanent stop end, thereby hitting the legs of the rider. Thus, it must be placed in a separate storage container, the pocket of the rider, or wrapped around the bike frame or lock frame in an unsightly fashion and somehow secured or tied off.

### SUMMARY

An example embodiment of the present invention is directed to an article for locking an accessory to a physical structure using a separate locking device. The article includes an elongate flexible rope having its ends secured, the rope having a twist so as to form two separate loop openings, and a stop provided at the location of the twist, the stop having a central opening enclosing the twist. One of the first and second loop openings is configured to be drawn up through an opening of the accessory until the stop abuts an interior surface within the accessory. The drawn up one of the first and second loop openings extends outside the accessory for receiving the separate locking device there through to lock the accessory via said one of the first and second loop openings and locking device to the physical structure.

Another example embodiment is directed to a combination for locking an accessory to a physical structure. The combination includes an elongate flexible rope having its ends secured, the rope having a twist so as to form two separate loop openings, a stop provided at the location of the twist, the stop having a central opening enclosing the twist, and a locking device. One of the loop openings extends outside the accessory for receiving the locking device there through to lock the accessory via the loop opening and locking device to the physical structure.

Another example embodiment is directed to a combination for locking a helmet to a bicycle or motorcycle. The combination includes an elongate flexible metal rope having its ends secured, the rope having a twist so as to form two separate loop openings, and a U-Lock useable with a bicycle or motorcycle. The U-Lock includes a U-shaped section extending into a pair of parallel tubular posts adapted to engage the bicycle or motorcycle and secured via a crosswise locking element. One of the loop openings extends outside the helmet for receiving a post of the U-Lock there through to lock the helmet via the loop opening and post to the bicycle or motorcycle. In a stowed or carry configuration, the metal rope is attached to one of the posts of the U-lock so that the post extends through both loop openings formed by the twist.

### BRIEF DESCRIPTION OF THE DRAWINGS

Example embodiments of the present invention will become more fully understood from the detailed description given herein below and the accompanying drawings, wherein like elements are represented by like reference numerals, which are given by way of illustration only and thus do not limit the example embodiments.

FIG. 1 is a perspective view of an article for locking an accessory to a physical structure using a separate locking device.

FIG. 2 illustrates a series of stripped portions of wire roping segments to show constituent components of the flexible metal rope in more detail.

FIG. 3 is a partial side-view of the article of FIG. 1.

FIG. 4 is a partial side view of an accessory with the article extending through an opening of the accessory.

FIG. 5 is a partial side-view of the article, accessory and an example locking device.

FIG. 6 is a perspective view illustrating the locking engagement of the accessory to the external structure via the article and locking device.

FIG. 7 is a perspective view of the article of FIG. 1 mounted on a locking device in an example stowed configuration.

### DETAILED DESCRIPTION

The example embodiments as to be described hereafter relate to an article for locking an accessory such as bike helmet in one example to a physical structure such as a bicycle in one example, using a separate locking device, and the combination thereof. Unless otherwise defined below, terms used to describe the example embodiments should be understood for their plain meaning.

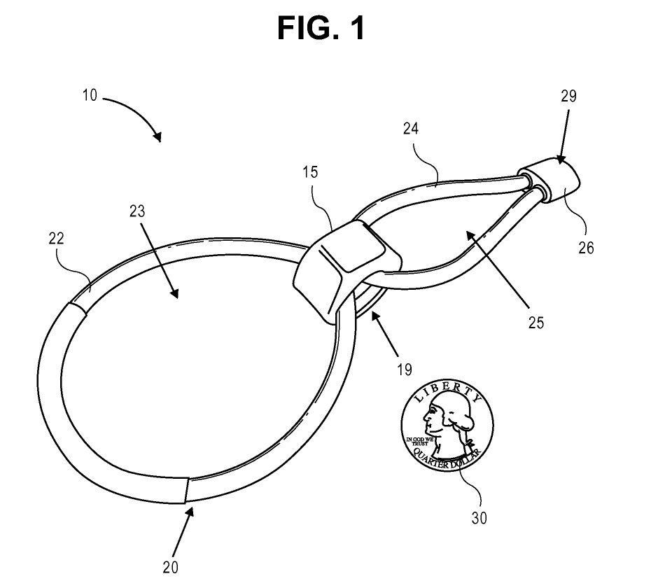

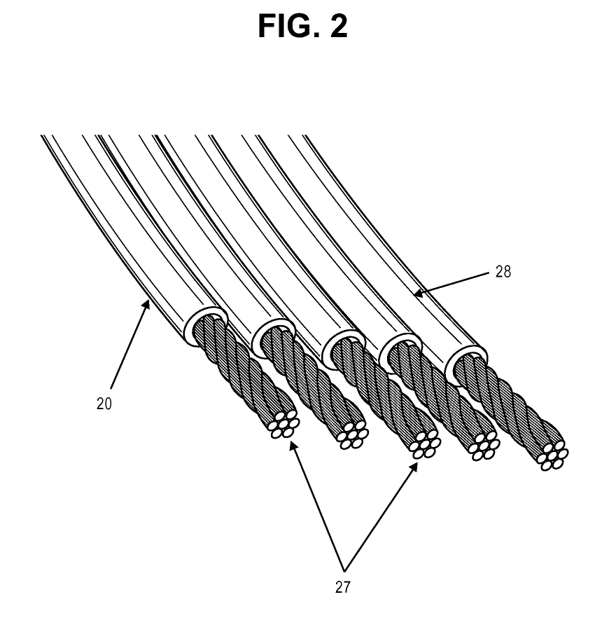

FIG. 1 is a perspective view of an article for locking an accessory to a physical structure using a separate locking device; FIG. 2 illustrates a series of stripped portions of wire roping segments to illustrate constituent components of the flexible metal rope in more detail. Referring to FIGS. 1 and 2, article 10 includes an elongate flexible metal rope 20. The metal rope may be comprised of a series of bound twisted metal fibers 27 composing the rope and covered with a rubber over-mold protective sheath 28 so as to form metal rope 20.

Flexible metal rope 20 has its ends secured by a sleeve 26. In an example sleeve 26 can be embodied as a metal crimping component with openings or slots to receive and secure the ends therein. Optionally, sleeve 26 may be covered or coated with a protecting rubber over mold 29. The ends of the metal rope 20 may be fastened together in another manner, as evident to the skilled artisan. In an example, rope 20 may be twisted at some point between the two ends thereof to form two separate loop openings, shown as a first loop opening 23 and a second loop opening 25.

A stop 15 is provided at the location of the twist, so that the metal rope 20 is divided into a first rope portion 22 with a first loop opening 23, and a second rope portion 24 with a second loop opening 25. As shown, the stop 15 has a central opening 19 enclosing the twist (not shown). Stop 15 is generally about the size of a quarter, with a diameter approximately 1 to 1¼ inches so as to stop any opening within an accessory 50 (not shown) less than or equal to 1¼ inches. This is to prevent the accessory 50 from sliding off article 10 during connection thereto.

The twist within the stop opening 19 is under sufficient tension that the two loops 23 and 25 can be set to a fixed size. However, if desire, each loop 23, 25 can be adjusted by a user simply by moving the wire rope 20 within the opening 19 (forcing movement of the wire rope 20 to overcome friction pressure) to adjust the size of the loops 23, 25.

In this example, the stop 15 is shown as a metal element having a central opening. Stop 15 may be formed from cast stainless steel or aluminum using a metal casting process such as sand casting, die casting, or investment casting, for example. In another example, stop 15 may be formed by an injection molding process from a high impact plastic, such as Acrylonitrile Butadiene Styrene (ABS), which is an easily machined, tough, low cost rigid thermoplastic material with high impact strength, and may be a desirable material for turning, drilling, milling, sawing, die-cutting, shearing, etc. Virgin ABS may be mixed with a plastic regrind of ABS or another lightweight, durable plastic material. ABS is merely an example material, equivalent materials may include various thermoplastic and thermoset materials, such as talc-filled polypropylene, high strength polycarbonates such as GE Lexan®, or blended plastics.

There are many known injection molding machines for forming plastic injection molds, other plastic molding processes such as vacuum forming may be used. In a further example, stop 15 may be composed of a carbon-fiber material.

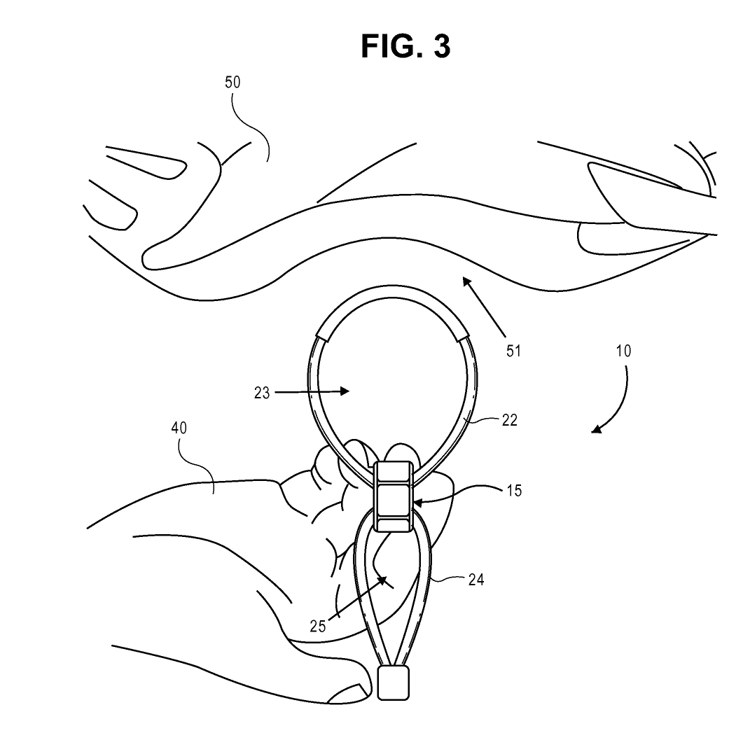

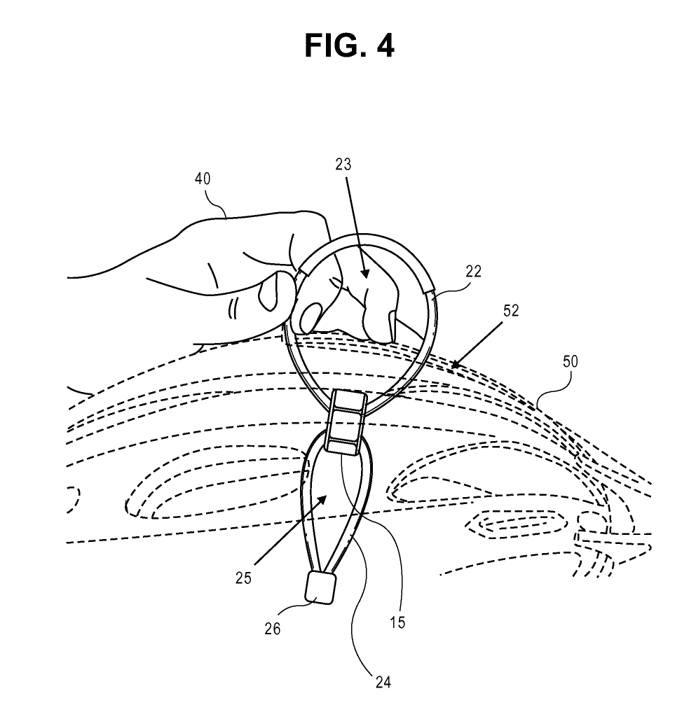

FIG. 3 is a partial side-view of the article of FIG. 1; FIG. 4 is a partial side view of an accessory with the article extending through an opening of the accessory. Referring to FIGS. 3 and 4, the first loop opening 23 formed by the first loop portion 22 (via the twist and held by stop 15) of article 10 is shown positioned so as to be insertable up through an opening 51 of an accessory 50; in this example the accessory 50 is a bike helmet, although it could be a motorcycle helmet or other package or container having an opening that could accommodate article 10. Alternatively, depending on the dimensions of the opening in the accessory 50, the second loop opening 25 could be positioned for insertion there through.

As shown, first loop opening 23 is positioned by a user 40 so as to be drawn up through a first opening 51 of the accessory 50 and out through a second opening 52 (in this particular example the helmet air vent), and fed by user 40 until the stop 15 abuts an interior surface within the accessory 50. This is shown best in FIG. 4. The first loop portion 22 with first loop opening 23 thus extends outside the accessory 50 for receiving a separate locking device (not shown) designed to lock the accessory 50 either directly or to an external structure via the locking device and first loop opening 23 of the article 10. Alternatively, depending on the size of the locking device, the second loop portion 24 with second loop opening 25 could be provided so as to receive the locking device.

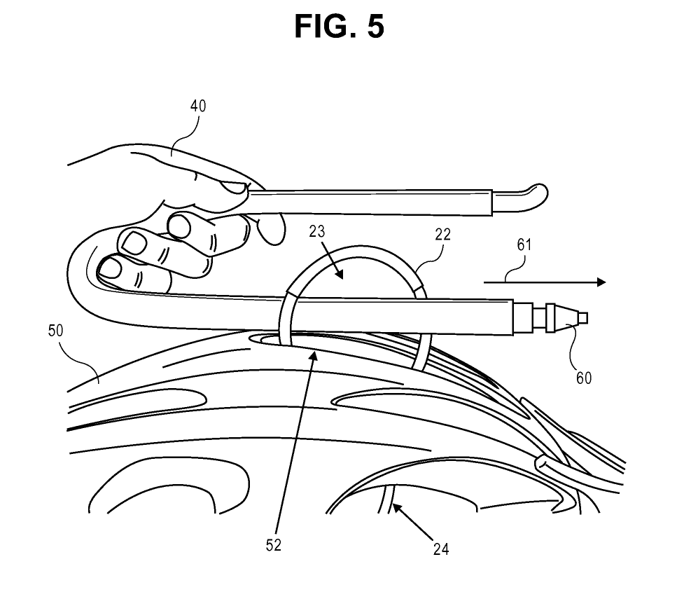

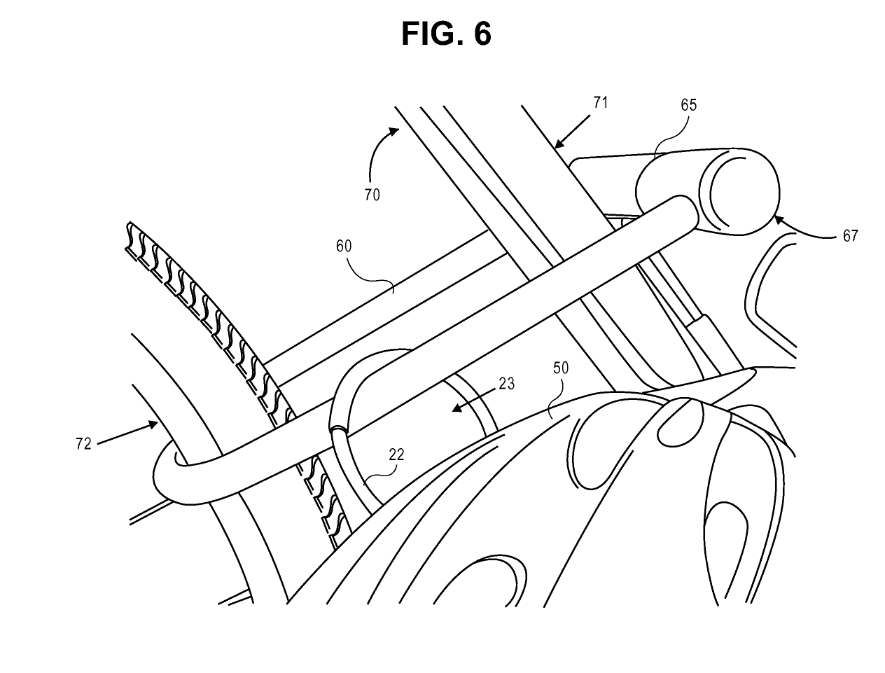

FIG. 5 is a partial side-view of the article, accessory and an example locking device; FIG. 6 is a perspective view illustrating the locking engagement of the accessory to the external structure via the article and locking device. Referring to FIGS. 5 and 6, the locking device 60 in this example is shown as a standard U-Lock bicycle locking device; however, article 10 is designed to cooperate with other locking devices of any size, such as a standard padlock, which can attached to any external structure to lock an accessory 50 thereto. Arrow 61 in FIG. 5 indicates the general direction in which U-Lock 60 is inserted by user 40 through first loop opening 23.

As best shown in FIG. 6, U-Lock 60 captures part of an external structure, in this example shown as a wheel rim 72, is inserted through first loop opening 23, and then is attached to locking mechanism 65 around additional external structure (shown here as the bike frame 71). The user 40 can then physically lock the U-Lock 60 at keyway 67; the accessory 50 (bike helmet in this example) is thus securely attached to the bicycle via article 10 and U-Lock 60. In other words, as the separate, existing locking device 60 is locked, the accessory 50 is secured in place by article 10.

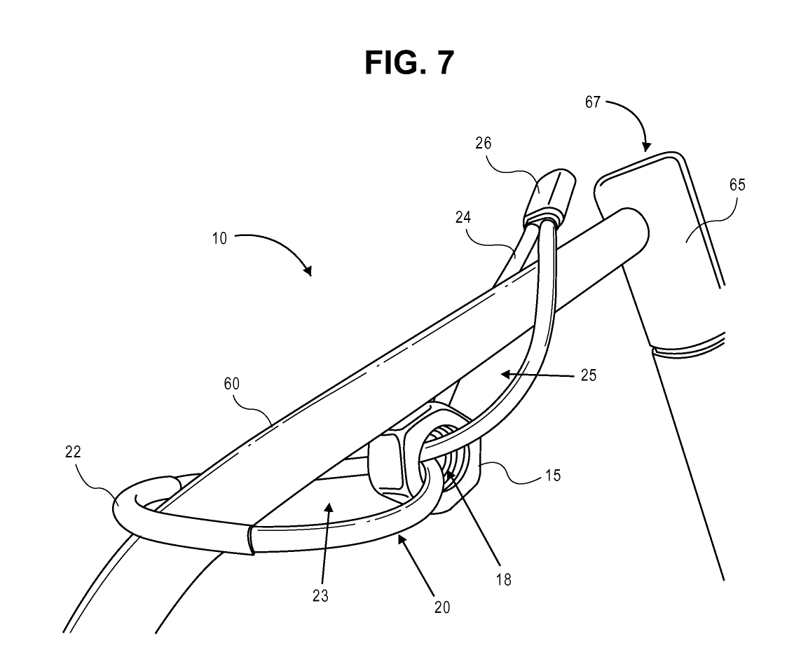

FIG. 7 is a perspective view of the article of FIG. 1 mounted on a locking device in an example stowed configuration. Referring to FIG. 7, when not in use, article 10 can be easily stowed on the locking device 60 for transport. In this particular example, article 10 can simply be attached to one of the tube parts of U-Lock 60 and stowed on the frame 71 of the bicycle 60 in the conventional manner.

Accordingly, having described an example article 10 for securing an accessory 50 to a physical structure via a separate locking device 60, it follows that the example embodiments offer a combination comprising the locking device 60 with article 10 for securing accessories 50 such as the aforementioned example helmet 50 to a physical structure such as a bicycle 70. The article 10 and combination may offer several benefits. In one example, the overall size and footprint of article 10 is small and easy to transport and stow, as evident by FIGS. 1 and 7; the article 10 and combination requires no additional fasteners, separate storage containers and/or straps when not in use. The article 10 only needs to be inserted through an accessory 50 and/or existing locking device 60 a single time. Further, each loop 23, 25 can be easily adjusted by user 40 to fit a desired opening size 51/52 in the accessory or accommodate given locking device 60 dimensions. Moreover, either loop portion 22/24 may be used for engagement with locking device 60.

The example embodiments being thus described, it will be obvious that the same may be varied in many ways. For example, the wire rope 20 may be threaded through the same side of the stop 15 instead of on either side of stop 15. Additionally, instead of wire rope 20 being composed of flexible metal fibers 27, rope 20 could be formed of rigid metal, rigid metal-carbon composite or carbon fiber composite or a tough ABS type material so that article 10 may be rigid instead of flexible. Further, in its alternative rigid construction article 10 may be formed with a curved rather than substantially flat orientation. Such variations are not to be regarded as departure from the example embodiments of the present invention. All such modifications as would be obvious to one skilled in the art are intended to be included within the following claims.

What is claimed is:

1. An article for locking an accessory to a physical structure using a separate locking device, comprising:
an elongate flexible rope having its ends secured, the rope having a twist so as to form two separate loop openings,
a stop provided at the location of the twist, the stop having a central opening enclosing the twist,
one of the first and second loop openings configured to be drawn up through an opening of the accessory until the stop abuts an interior surface within the accessory, the drawn up one of the first and second loop openings extending outside the accessory for receiving the separate locking device there through to lock the accessory via said one of the first and second loop openings and locking device to the physical structure.

2. The article of claim 1, wherein the rope further includes of plurality of bound twisted metal fibers covered with a rubber over-mold protective sheath.

3. The article of claim 1, wherein the ends of the rope are secured by a metal sleeve covered with a protective rubber material.

4. The article of claim 1, wherein the stop has a diameter in a range of approximately 1 to 1¼ inches

5. The article of claim 1, wherein the rope is formed from one of a metal, carbon-fiber and plastic composite material.

6. The article of claim 1, wherein the stop is formed from one of a metal, carbon-fiber and plastic composite material.

7. The article of claim 1, wherein the twist within the stop opening is under tension to set each loop opening to a fixed size.

8. The article of claim 1, wherein each loop opening is adjustable by a user moving the rope within the opening to overcome friction pressure imposed by the stop opening on the twist.

9. The article of claim 1, wherein the accessory is a helmet for a bicycle or motorcycle.

10. The article of claim 1, wherein the locking device is one or a U-lock or padlock useable to lock a bicycle or motorcycle.

11. A combination for locking an accessory to a physical structure, comprising;
an elongate flexible rope having its ends secured, the rope having a twist so as to form two separate loop openings,
a stop provided at the location of the twist, the stop having a central opening enclosing the twist, and
a locking device,
one of the loop openings extending outside the accessory for receiving the locking device there through to lock the accessory via the loop opening and locking device to the physical structure.

12. The combination of claim 11, wherein the twist within the stop opening is under tension to set each loop opening to a fixed size.

13. The combination of claim 11, wherein each loop opening is adjustable by a user moving the rope within the opening to overcome friction pressure imposed by the stop opening on the twist.

14. The combination of claim 11, wherein the twist within the stop opening is under tension to set each loop opening to a fixed size.

15. The combination of claim 11, wherein the locking device is a U-Lock useable with a bicycle or motorcycle, the U-Lock including a U-shaped section extending into a pair a parallel tubular posts adapted to engage the physical structure and secured via a crosswise locking element.

16. The combination of claim 15, wherein, in a stowed or carry configuration, the rope is attached to one of the posts of the U-lock so that the post extends through both loop openings formed by the twist.

17. A combination for locking a helmet to a bicycle or motorcycle, comprising;
an elongate flexible metal rope having its ends secured, the rope having a twist so as to form two separate loop openings,
a U-Lock useable with a bicycle or motorcycle, the U-Lock including a U-shaped section extending into a pair a parallel tubular posts adapted to engage the bicycle or motorcycle and secured via a crosswise locking element, wherein
one of the loop openings extends outside the helmet for receiving a post of the U-Lock there through to lock the helmet via the loop opening and post to the bicycle or motorcycle, and
in a stowed or carry configuration, the metal rope is attached to one of the posts of the U-lock so that the post extends through both loop openings formed by the twist.

18. The combination of claim 17, further comprising:
a stop provided at the location of the twist, the stop having a central opening enclosing the twist.

19. The combination of claim 18, wherein the twist within the stop opening is under tension to set each loop opening to a fixed size.

20. The combination of claim 18, wherein each loop opening is adjustable by a user moving the rope within the opening to overcome friction pressure imposed by the stop opening on the twist.
